(19) United States
(12) Patent Application Publication
(10) Pub. No.: US 2013/0057100 A1
(43) Pub. Date: Mar. 7, 2013

(54) ELECTRIC ROTARY MACHINE

(71) Applicants: Akira FUKUSHIMA, Kariya-shi (JP); Shin Kusase, Obu-shi (JP)

(72) Inventors: Akira FUKUSHIMA, Kariya-shi (JP); Shin Kusase, Obu-shi (JP)

(73) Assignee: DENSO CORPORATION, Kariya-city (JP)

(21) Appl. No.: 13/602,728

(22) Filed: Sep. 4, 2012

(30) Foreign Application Priority Data
Sep. 5, 2011 (JP) 2011-192755

(51) Int. Cl. H02K 16/02

(52) U.S. Cl. 310/114

(57) ABSTRACT

An electric rotary machine has a stator, a second rotor, and a first rotor which are arranged in order on a coaxial shaft. The first rotor has a plurality of magnetic poles having a different polarity. The stator has stator winding wires. The second rotor has a magnetic iron core and short circuit conductors. The magnetic iron core has first magnetic passage parts, second magnetic passage parts, and conductor holder parts. Both ends of the short circuit conductor is electrically connected to make a short circuit. The short circuit conductors are fitted to the corresponding conductor holder parts. No short circuit conductor surrounds each of the first magnetic passage parts. The short circuit conductors surround each of the second magnetic passage parts. The first magnetic passage parts and the second magnetic passage parts are alternately arranged along a circumferential direction of the second rotor.

### CROSS-REFERENCE TO RELATED APPLICATION

This application is related to and claims priority from Japanese Patent Application No. 2011-192755 filed on Sep. 5, 2011, the contents of which are hereby incorporated by reference.

### BACKGROUND OF THE INVENTION

1. Field of the Invention

The present invention relates to electric rotary machines, composed of a first rotor, a second rotor, a stator and other components, capable of generating an increased magnetic flux effective to increase a torque density and an output power density.

2. Description of the Related Art

There has been disclosed a conventional technique of an electric rotary machine. For example, Japanese patent publication No. 4505524 discloses an electric rotary machine having a conventional structure. The conventional electric rotary machine is composed of a first electric rotary machine, a second electric rotary machine, and other components. The first electric rotary machine is composed of a stator, a first rotor, a second rotor, and etc.

The first rotor has a magnetic pole row arranged to face an armature row. The magnetic pole row has a plurality of magnetic poles. The magnetic poles in the magnetic pole row are arranged in a circumferential direction of the first rotor at a predetermined distance spaced to each other. The adjacent magnetic poles in the magnetic pole row have a different magnetic polarity relative to each other.

The second rotor has a soft magnetic material element row arranged between the armature row and the magnetic pole row. The soft magnetic material element row is composed of a plurality of soft magnetic material elements. The soft magnetic material elements are arranged at a predetermined distance spaced to each other in a circumferential direction of the second rotor.

An input shaft of the first electric rotary machine is mechanically connected to an output shaft of an internal combustion engine. AN output shaft of the first electric rotary machine is mechanically connected to a rotary shaft of the second electric rotary machine.

There has been disclosed another conventional technique of an electric rotary machine. For example, Japanese patent publication No. 4648378 discloses an electric rotary machine having a first rotor and a second rotor.

The first rotor is composed of a first permanent magnet row, a second permanent magnet row arranged in parallel along an axial direction of the electric rotary machine, and etc. The first permanent magnet row in the first rotor has a plurality of first permanent magnets arranged so that adjacent first permanent magnets have a different magnetic polarity relative to each other. The second permanent magnet row in the first rotor has a plurality of second permanent magnets arranged so that adjacent second permanent magnets have a different magnetic polarity relative to each other.

The second rotor is composed of a first induction magnetic pole row and a second induction magnetic pole row arranged in parallel along an axial direction of the electric rotary machine. The first induction magnetic pole row has a plurality of first induction magnetic poles made of soft magnetic material. The second induction magnetic pole row has a plurality of second induction magnetic poles made of soft magnetic material.

However, the conventional techniques previously described need to have non-magnetic supporting members in order to provide a magnetic shield capability and a centrifugal force resistance. The presence of such a non-magnetic supporting member having the magnetic shield capability and the centrifugal force resistance decreases a magnetic leakage between the first induction magnetic poles and the second induction magnetic poles made of soft magnetic material elements in the second rotor as large as possible, and thereby provides a requested output torque.

Further, a soft magnetic material element and a nonmagnetic material element make a pair, which are alternately arranged in a circumferential direction of the second rotor, the second rotor in the conventional techniques previously described is a reluctance type rotor which uses a magnetic resistance change. Accordingly, the second rotor has a relatively low torque density and outputs a relatively low output power density when compared with those of a rotor in which permanent magnets are embedded. For this reason, there is a strong demand for electric rotary machines (for used in hybrid electric vehicles and electric vehicles) to provide an increased torque density and an increased output power density.

### SUMMARY

It is therefore desired to provide an electric rotary machine having a simple structure, which is manufactured with a low cost, and generating an increased magnetic flux effective to increase a torque density and an output power density.

An exemplary embodiment provides an electric rotary machine having a stator, a first rotor and a second rotor. The stator has stator winding wires. The first rotor has a plurality of magnetic poles having a different polarity. The second rotor is arranged between the first rotor and the stator. The first rotor, the second rotor and the stator are sequentially arranged on a coaxial shaft. The second rotor has a magnetic iron core and a plurality of short circuit conductors. In particular, the magnetic iron core of the second rotor has at least one or more first magnetic passage parts, at least one or more second magnetic passage parts, and a plurality of the conductor holder parts. Both ends of each of the short circuit conductors are electrically connected to make a short circuit. The short circuit conductor is fitted to the corresponding conductor holder part. No short circuit conductor surrounds each of the first magnetic passage parts. That is, the first magnetic passage parts have no short circuit conductor surrounding them. The short circuit conductors surround each of the second magnetic passage parts. Further, the first magnetic passage parts and the second magnetic passage parts in the second rotor are adjacently arranged in a circumferential direction of the second rotor.

In the structure of the second rotor in the electric rotary machine according to the exemplary embodiment of the present invention, the first magnetic passage parts and the second magnetic passage parts are adjacently arranged on a circumferential direction (or a revolution direction) of the second rotor. The first magnetic passage parts bridge and flow the magnetic flux between the first rotor and the stator in a radial direction (that is, in a radial direction of the electric rotary machine). The second magnetic passage parts cancel leakage of the magnetic flux in a circumferential direction of the second rotor (as a capability of shielding a magnetic flux in a circumferential direction). This makes it possible to increase the magnetic flux effective to increase the output torque of the electric rotary machine. As a result, this makes if possible to increase the torque density and the output power density of the electric rotary machine.

The electric rotary machine according to the exemplary embodiment of the present invention is a device composed of a stator, a rotor and etc. The rotor can be connected directly or indirectly, and physically or mechanically, to rotary members such as a shaft of an external device. It is also possible to assemble the rotor and the rotary members of the external device together. For example, there are, as the electric rotary machine, electric generators, electric motors, electric motor generators, etc. It is possible for each of the conductor holder parts to have various structures. One pair of the conductor holder parts corresponds to each of the short circuit conductors. Each of the conductor holder parts has one or more mounting parts selected from notch parts, through holes, cavity parts, etc. Each of the short circuit conductors is selected from winding wires, coil, etc. Both ends of each of the short circuit conductors is connected together to make a short circuit. It is possible to use various materials to make the magnetic iron core unless it can be magnetized. For example, a soft magnetic material is used as the magnetic iron core. It is also possible to use a hard magnetic material and a non-magnetic material as a part of the magnetic iron core. Through the description, the technical words “adjacent” and “adjacently connected” allow the parts to be or not to be in contact with to each other

### BRIEF DESCRIPTION OF THE DRAWINGS

A preferred, non-limiting embodiment of the present invention will be described by way of example with reference to the accompanying drawings, in which:

FIG. 1 is a schematic view showing a cross section along an axial direction of an electric rotary machine according to various exemplary embodiments of the present invention;

FIG. 2 is a schematic view showing a partial cross section along a radial direction of the electric rotary machine according to the first exemplary embodiment of the present invention;

FIG. 3 is a schematic view showing a distribution of a magnetic flux in the electric rotary machine according to the first exemplary embodiment of the present invention;

FIG. 4 is a schematic view showing a distribution of a magnetic flux as a comparative example of an electric rotary machine;

FIG. 5 is a schematic view showing a distribution of a magnetic flux as another comparative example of an electric rotary machine;

FIG. 6 is a graph showing a change with the passage of time of an output torque of the electric rotary machine according to the first exemplary embodiment of the present invention;

FIG. 7 is a schematic view showing a partial cross section along a radial direction of an electric rotary machine according to a second exemplary embodiment of the present invention;

FIG. 8A is a-schematic view showing a partial cross section along a radial direction of an electric rotary machine according to a third exemplary embodiment of the present invention;

FIG. 8B is a schematic view showing a partial cross section of a second rotor in the electric rotary machine according to the third exemplary embodiment of the present invention;

FIG. 9 is a schematic view showing a partial cross section along a radial direction of an electric rotary machine according to a fourth exemplary embodiment of the present invention;

FIG. 10 is a schematic view showing a partial cross section along a radial direction of an electric rotary machine according to a fifth exemplary embodiment of the present invention;

FIG. 11 is a schematic view showing a partial cross section along a radial direction of an electric rotary machine according to a sixth exemplary embodiment of the present invention; and

FIG. 12 is a schematic view showing a partial cross section along a radial direction of an electric rotary machine according to a seventh exemplary embodiment of the present invention.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

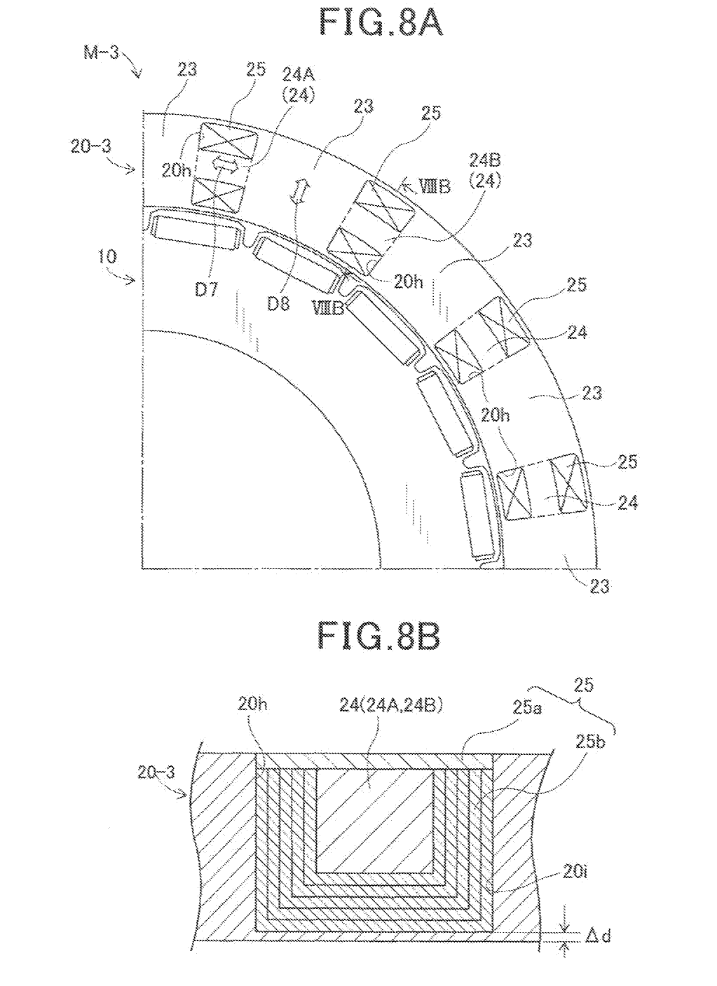

In the following description, the technical terms “connection”, “connected to” indicate “electrical connection” and “electrically connected to”, respectively. Further, hatching lines which are closely spaced parallel lines are omitted from each cross section of the drawings other than FIG. 8B for easy understanding.

### First Exemplary Embodiment

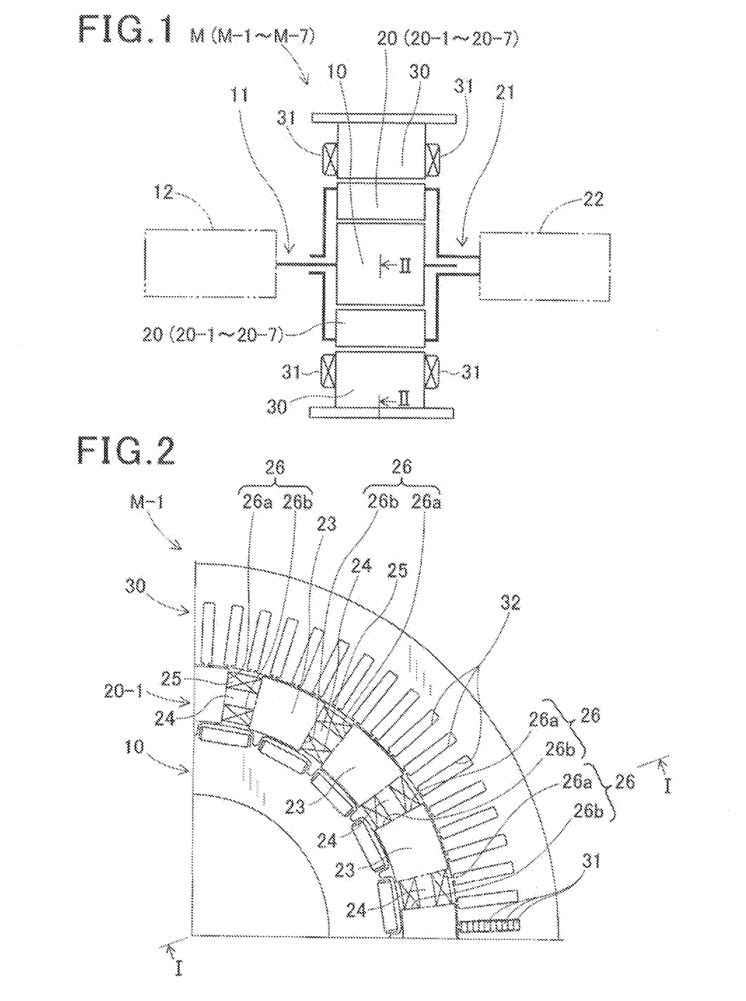

A description will be given of an electric rotary machine M-1 according to a first exemplary embodiment of the present invention with reference to FIG. 1 to FIG. 6. The electric rotary machine M-1 according to the first exemplary embodiment is used in hybrid electric vehicles (HEV). The electric rotary machine M-1 according to the first exemplary embodiment has a plurality of conductor holder parts arranged in a second rotor of a radial direction of the electric rotary machine M-1. Each of the conductor holder parts is composed of a first notch part and a second notch part which will be explained later in detail.

FIG. 1 is a schematic view showing a cross section along an axial direction of the electric rotary machine M-1 according to the various exemplary embodiments of the present invention. For example, FIG. 1 is a schematic arrow view along the I-I line shown in FIG. 2.

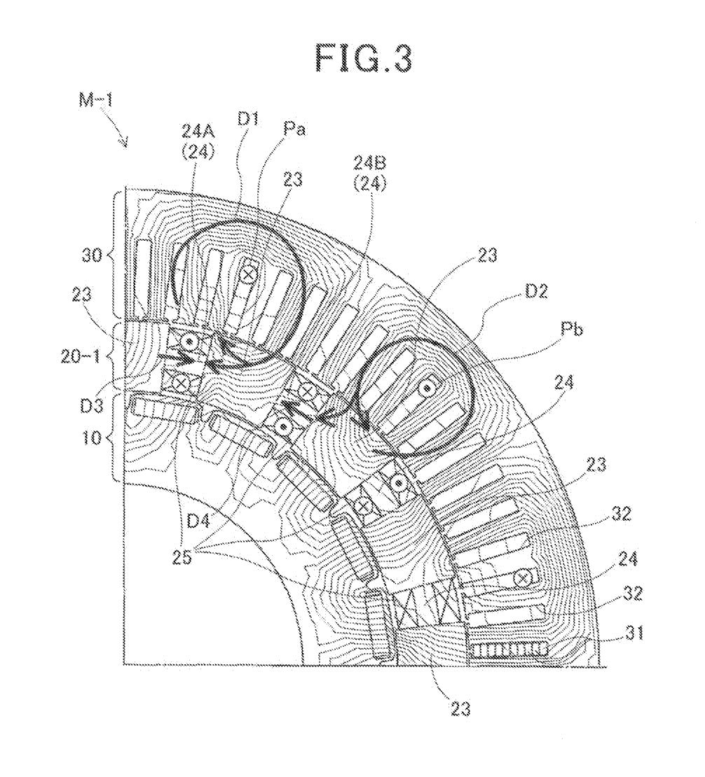

FIG. 2 is a schematic view showing a partial cross section along a radial direction of the electric rotary machine according to the first exemplary embodiment of the present invention. That is, FIG. 2 is a schematic arrow view along the II-II line shown in FIG. 1. FIG. 3 is a schematic view showing a distribution of a magnetic flux in the electric rotary machine M-1 according to the first exemplary embodiment.

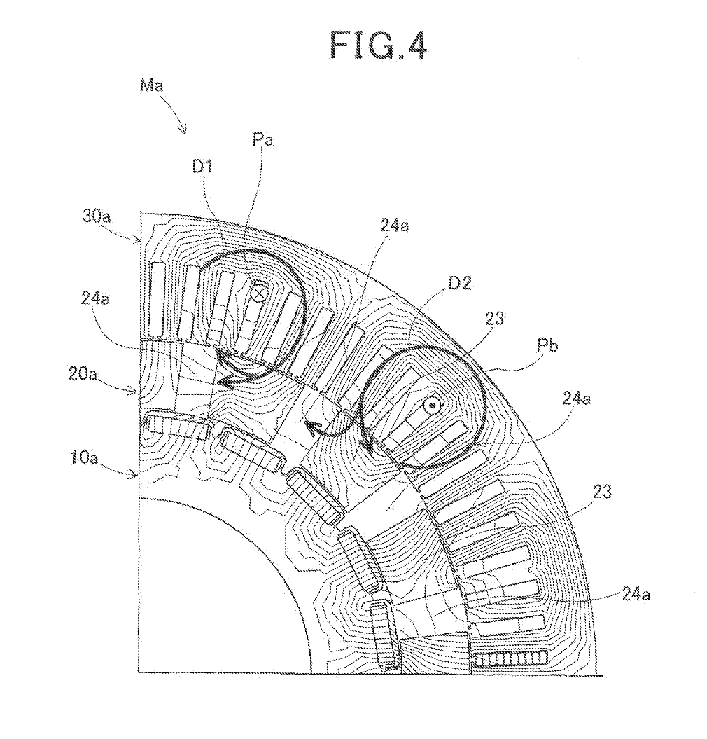

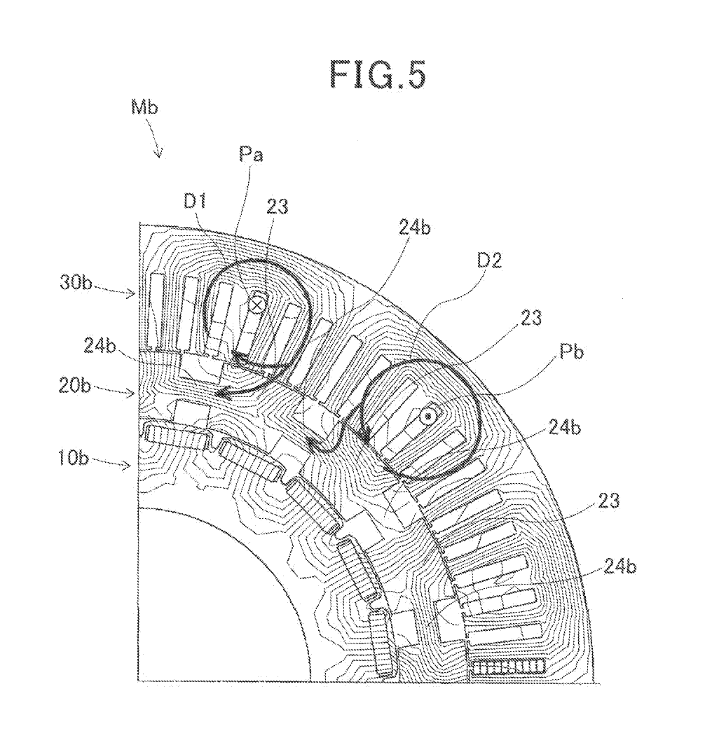

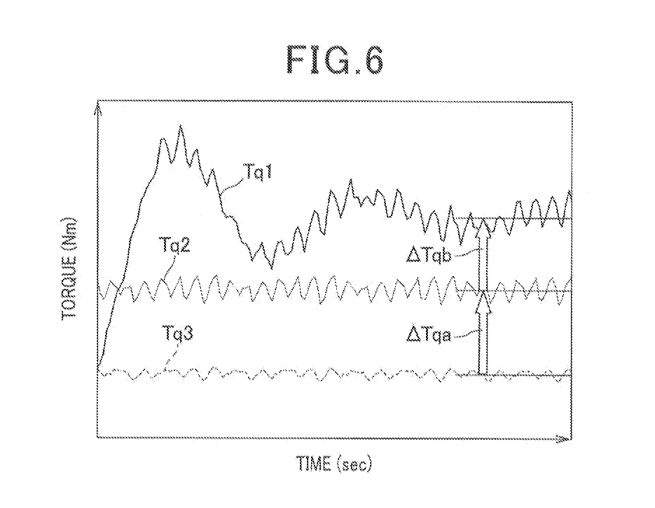

FIG. 4 shows a distribution of a magnetic flux in an electric rotary machine as a comparative example. FIG. 5 shows a distribution of a magnetic flux in an electric rotary machine as another comparative example. FIG. 6 is a graph showing a change with the passage of time of an output torque of the electric rotary machine M-1 according to the first exemplary embodiment of the present invention.

The electric rotary machine M-1 according to the first exemplary embodiment shown in FIG. 1 and FIG. 2 has a first rotor 10, a second rotor 20-1, a stator 30, etc. The first rotor 10, the second rotor 20-1 and the stator 30 are arranged in a coaxial shaft of the electric rotary machine M-1. The second rotor 20-1 is arranged between the first rotor 10 and the stator 30. That is, the stator 30 is arranged at the most outer circumference of the electric rotary machine M-1.

For example, as shown in FIG. 1, a rotary shaft 11 of the first rotor 10 is an input axial shaft. The electric rotary machine M-1 receives power transmitted from a power source (for example, an internal combustion engine, an electric machine, and etc.) through the rotary shaft 11. For example, the rotary shaft 11 of the first rotor 10 is connected with an engine shaft 12 (or a crank shaft) designated by an alternate long and two short dashed line at the left side in FIG. 1.

A rotary shaft 21 of the second rotor 20-1 is an output shaft of the electric rotary machine M-1. Through the rotary shaft 21 of the second rotor 20-1, the electric rotary machine M-1 of the first exemplary embodiment outputs a converted output power. It is possible to connect the rotary shaft 21 of the second rotor 20-1 with any shaft such as a transmission shaft 22 designated by an alternate long and two short dashed line shown at the right side in FIG. 1.

The stator 30 has stator winding wires 31 in order to generate rotary magnetic field. The stator winding wires 31 are accommodated in a plurality of slots 32 (shown in FIG. 2). The electric rotary machine M-1 according to the first exemplary embodiment has multiphase winding wires (for example, three phase winding wires of the U phase, the V phase and the W phase).

FIG. 2 shows only one stator winding wire 31 in the stator 30 at the right bottom side for brevity. The stator winding wire 31 is wound around the slot 32. In an actual case, the stator winding wires 31 are wound around ail of the slots 32. These stator winding wires 31 are connected in order to make the multiphase windings.

A description will now be given of a first structure of the electric rotary machine M-1 according to the first exemplary embodiment with reference to FIG. 2. FIG. 2 shows a quarter of the entire of the electric rotary machine M-1 according to the first exemplary embodiment.

In the first rotor 10, a plurality of magnets is arranged in the first rotor 10 so that the adjacent magnets have a different magnetic polarity relative to each other The adjacent magnets make a magnet pair. Each magnet pair has two magnets having a different magnetic polarity. It is sufficient for the first rotor 10 to have a synchronous motor When the electric rotary machine M-1 is applied to hybrid electric motor (HEV) having a smaller body, it is preferred to use, as the first rotor 10, a surface permanent magnet (SPM) rotor using high performance magnets, and an interior permanent magnet (IPM) rotor.

The first exemplary embodiment uses an IPM rotor having a surface magnetic flux distribution of an approximate sine curve in order to suppress fluctuation of an output torque of the electric rotary machine M-1.

The second rotor 20-1 is made of soft magnetic material (laminated magnetic steel plates) sequentially arranged along a circumferential direction of the second rotor 20-1. The second rotor 20-1 has a plurality of conductor holder parts 26. As shown in FIG. 2, each of the conductor holder parts 26 is composed of a notch portion 26a and a notch portion 26b. The pair of the notch portion 26a and the notch portion 26b is arranged in a radial direction of the electric rotary machine M-1. A plurality of the conductor holder parts 26 is arranged along a circumferential direction of the second rotor 20-1. In each conductor holder part 26 composed of the pair of the notch portion 26a and the notch portion 26b, the notch portion 26a is arranged at an outer circumferential side and the notch portion 26b is arranged at an inner circumferential side. The notch portion 26a and the notch portion 26b have a cavity part (or a concave part). A short circuit conductor 25 is fitted and fixed into each of the conductor holder parts 26. That is, the short circuit conductor 25 is fitted and fixed into the pair of the notch portion 26a and the notch portion 26b.

The short circuit conductor 25 is made of a conductor such as a winding wire or a coil. Both ends of the short circuit conductor 25 are electrically connected together to make a short circuit. There are various methods of making a short circuit. For example, both ends of the short circuit conductor 25 are electrically and directly connected together by soldering or welding, or both ends of the short circuit conductor 25 are electrically connected together through a conductive plate (for example, metal plate). Further, there are many methods of fitting the short circuit conductor 25 to the corresponding conductor holder part 26 composed of the notch portion 26a and the notch portion 26b, For example, the short circuit conductor 25 is fitted and fixed into the corresponding conductor holder part 26 (26a, 26b). That is, the conductor holder parts 26 surround the short circuit conductor 25. The part of the second rotor 20-1 arranged between the notch portion 26a and the notch portion 26b in the pair corresponds to a second magnetic passage part 24 which will be explained in detail later.

The presence of the conductor holder parts 26 allows the second rotor 20-1 to have a first magnetic passage part 23 and the second magnetic passage part 24 which are alternately arranged in the second rotor 20-1. Although the first magnetic passage part 23 and the second magnetic passage part 24 are alternately arranged at the same interval, it is acceptable to arrange at least a part of the first magnetic passage parts 23 and the second magnetic passage parts 24 in the second rotor 20-1 at an irregular interval due to a structural specification of the electric rotary machine M-1 and/or due to a surrounding environment of the mounting place to which the electric rotary machine M-1 is mounted.

Magnetic flux passes between the first rotor 10 and the stator 30 through each of the first magnetic passage parts 23. The adjacent first magnetic passage parts 23 are electrically and magnetically connected through the corresponding second magnetic passage part 24. The short circuit conductors 25 are fitted to the notch portion 26a and the notch portion 26b in the conductor holder part 26. The notch portion 26a is arranged at the outer circumferential part of the second magnetic passage part 24. The notch portion 26b is arranged at the inner circumferential part of the second magnetic passage part 24. That is, the second magnetic passage part 24 is surrounded by the notch portion 26a and the notch portion 28b. The short circuit conductors 25 are fitted and fixed into the notch portion 26a and the notch portion 26b formed in at the outer circumferential part and the inner circumferential part of the second magnetic passage part 24. The presence of the short circuit conductors 25 in the second magnetic passage parts 24 can cancel the magnetic flux leakage between the adjacent first magnetic passage parts 23.

In the first exemplary embodiment, the first rotor 10 and the second rotor 20-1 have a different number of pole pairs. That is, the first rotor 10 has the number P₁ of pole pairs, and the second rotor 20-1 has the number P₂ of pole pairs. The electric rotary machine M-1 according to the first exemplary embodiment has a relationship of P₂=P₁+P₃, where P₁ is the number of pole pairs in the first rotor 10, P₂ is the number of pole pairs in the second rotor 20-1, and P₃ is the number of pole pairs in the stator 30. For example, the first exemplary embodiment has a combination of P₁, P₂ and P₃, where P₁=10, P₂=16, and P₃=6. The relationship of P₂=P₁+P₃ makes it possible to generate magnetic connection between the first rotor 10, the second rotor 20-1 and the stator 30. In this case, the total number (=16 of the first magnetic passage part 23 arranged in a circumferential direction of the second rotor 20-1 is the number P₂ of pole pairs.

It is possible to run the first rotor 10 and the second rotor 20-1 at a different rotation speed. For example, it is possible to use the electric rotary machine M-1 according to the first exemplary embodiment as a variable speed motor capable of electrically and magnetically changing a rotation speed thereof when a current having a frequency f(=P₂N₂−P₁N₁) Hz flows in the stator 10 and the first rotor 10 rotates at a first rotation speed N1 [r/sec], and the second rotor 20-1 rotates at a second rotation speed N2 [r/sec].

FIG. 3 shows the distribution of magnetic flux by using lines of the magnetic flux flow on the basis of the “Ampere's circuit law”. In particular, the thin lines indicate the lines of magnetic flux flow, a circle with a cross mark “X” indicates a current which flows from near side toward back side on FIG. 3, a circle with a dark spot mark “•” indicates a current which flows from back side to near side on FIG. 3.

In FIG. 3, when the magnetic flux which is leaked between the adjacent first magnetic passage parts 23 is generated or varied, the leakage magnetic flux passes through the second magnetic passage part 24. In this case, an induced current is generated in the short circuit conductors 25 between the adjacent first magnetic passage parts 23 in order to eliminate the change of the leakage magnetic flux, where the second magnetic passage part 24 is surrounded by the short circuit conductors 25. When such an induced current is generated in the short circuit conductor 25, a magnetic field (or a magnetic flux) is generated on the basis of the Ampere's right-handed screw rule.

The magnetic flux generated by such an induced current in the short circuit conductors 25 cancels or increases a magnetic flux leakage generated between the adjacent first magnetic passage parts 23 according to the direction of the generated magnetic flux. A description will now be given of the induced current in detail.

FIG. 3 shows a distribution of a magnetic flux at a time when at least one of the first rotor 10 and the second rotor 20-1 rotate. Specifically, a magnetic flux is generated in a clockwise direction (designated by the arrow D1) around the circle with a cross mark “X” at the position Pa of the stator 30. Similarly, another magnetic flux is generated in a counter clockwise direction (designated by the arrow D2) around the circle with a dark spot mark “•” at the position Fb of the stator 30. The same phenomenon is generated at other parts of the stator 30 in which the magnetic flux in the clockwise direction and the magnetic flux in the counter clockwise direction are alternately generated in the stator 30.

In the following explanation, as shown in FIG. 3, the second magnetic passage part 24 at the left side will be referred to as the second magnetic passage part 24A and the second magnetic passage part 24 at the right side will he referred to as the second magnetic passage part 24B in order to distinguish them clearly.

As shown in FIG. 3, a part of magnetic flux in the clockwise direction generated around the point Pa is leaked through the second magnetic passage part 24A toward the left side which is the opposite direction designated by the arrow D3. When such a magnetic flux leakage in the second magnetic passage part 24A is varied in a time elapse, the induced current is generated in the short circuit conductors 25 in order to prevent the magnetic flux from being varied in the second magnetic passage part 24A, where the short circuit conductors 25 surround the second magnetic passage part 24A. That is, the magnetic flus (magnetic field) is generated in the opposite direction (designated by the arrow D3) of the direction of the magnetic flux leakage.

Because the leaked magnetic flux and the magnetic flux generated by the induced current in the short circuit conductor 25 are cancelled relative to each other in the second magnetic passage part 24A, the magnetic flux in the second magnetic passage part 24A is approximately cancelled. This makes it possible to magnetically separate, namely, cut the magnetic flux toward the circumferential direction of the electric rotary machine M-1.

On the other hand, as shown in FIG. 3, a part of magnetic flux in the counter clockwise direction generated around the point Pb is leaked through the second magnetic passage part 24B toward the left side which is the direction designated by the arrow D4. When such a magnetic flux leakage in the second magnetic passage part 24B is varied in a time elapse, an induced current is generated in the short circuit conductors 25, which surround the second magnetic passage part 24B, in order to prevent the magnetic flux from being varied.

In the second magnetic passage part 24B, a torque (kφbI, where k is a constant value) is generated, which is in proportional to orthogonal components between the current (I) and the stator magnetic flux (φb) of the stator 30.

A current is generated and flows in the short circuit conductor 25 so as to cancel the magnetic flux leakage in the second magnetic passage part 24A along the circumferential direction of the electric rotary machine M-1. Further, the current is generated in the short circuit conductor 25 so as to increase the magnetic flux along the second magnetic passage part 24B. The structure of the electric rotary machine according to the first exemplary embodiment makes it possible for the first magnetic passage parts 23 and the second magnetic passage part 24 (composed of the second magnetic passage part 24A and the second magnetic passage part 24B) to have a different magnetic flux phase relative to each other. It is therefore possible to improve a magnetic modulation capability of the second rotor 20-1.

A description will now be given of the change of magnetic flux in various structures of electric rotary machines with reference to FIG. 4 and FIG. 5.

FIG. 4 shows a structure of an electric rotary machine composed of a first rotor 10a, a second rotor 20a and a stator 30a. The first rotor 10a, the second rotor 20a, the stator 30a shown in FIG. 4 correspond to the first rotor 10, the second rotor 20-1 and the stator 30 in the electric rotary machine M-1 shown in FIG. 2, respectively.

The structure of the electric rotary machine shown in FIG. 4 has second magnetic passage parts 24a, each of which is made of non-magnetic material, instead of using the second magnetic passage parts 24 shown in FIG. 2 and FIG. 3.

Because the second magnetic passage parts 24a are made of non-magnetic material, no magnetic flux passes through it. Further, the structure of the electric rotary machine shown in FIG. 4 has no short circuit conductor 25 in the conductor holder parts 26.

FIG. 4 shows the distribution of magnetic flux in the same conditions of the distribution of magnetic flux shown in FIG. 3.

Like the structure shown in FIG. 3, a magnetic flux is generated in the clockwise direction around the position Pa and a magnetic flux is generated in the counter clockwise direction around the position Pb in the electric rotary machine shown in FIG. 4. Although the magnetic flux in the clockwise direction and the magnetic flux in the counter clockwise direction pass through the first magnetic passage part 23, approximately all of the magnetic flux passes through the second magnetic passage part 24. That is, no magnetic flux leakage occurs. If is therefore possible to separate the magnetic flux in the circumferential direction in the structure of the electric rotary machine shown in FIG. 4, like the case of the second magnetic passage part 24A shown in FIG. 3. However, the structure of the electric rotary machine shown in FIG. 4 does not generate any bias torque, like the additional torque generated in the short circuit conductor 25 shown in FIG. 3 by a current (I) and a stator magnetic flux (φb).

FIG. 5 shows another comparative structure of an electric rotary machine composed of a first rotor 10b, a second rotor 20b and a stator 30b. The first rotor 10b, the second rotor 20b, the stator 30b shown in FIG. 5 correspond to the first rotor 10, the second rotor 20-1 and the stator 30 in the electric rotary machine M-1 shown in FIG. 2, respectively.

A second magnetic passage part 24b shown in FIG. 5 is made of magnetic material element, like the second magnetic passage part 24 shown in FIG. 2. The electric rotary machine shown in FIG. 5 does not have any conductor holder parts 26 shown in FIG. 2.

FIG. 5 shows the distribution of magnetic flux in the same conditions of the distribution of magnetic flux shown in FIG. 3. Like the structure of the electric rotary machine M-1 shown in FIG. 3, a magnetic flux is generated in the clockwise direction around the position Pa and a magnetic flux is generated in the counter clockwise direction around the position Pb in the electric rotary machine shown in FIG. 5. Although the magnetic flux in the clockwise direction and the magnetic flux in the counter clockwise direction pass through the first magnetic passage part 23 and a part of the magnetic flux is leaked through the second magnetic passage part 24b. However, because the electric rotary machine as another comparative example shown in FIG. 5 does not have any short circuit conductor 25, it is impossible for the electric rotary machine as the comparative example shown in FIG. 5 to cancel any magnetic flux leakage by using a magnetic flux generated by an induced current.

A description will now be given of the change of torque of each of the electric rotary machines shown in FIG. 3, FIG. 4 and FIG. 5 with reference to FIG. 6.

In FIG. 6, a vertical line indicates a torque [Nm], a horizontal axis indicates a time [sec]. FIG. 6 shows a change of torque in the elapse of time. The bold line indicates the torque characteristic line Tq₁ of the electric rotary machine M-1 shown in FIG. 3. The solid line indicates the torque characteristic line Tq₂ of the electric rotary Ma shown in FIG. 4. The dotted line indicates the torque characteristic line Tq₃ of the electric rotary machine Mb shown in FIG. 5. These torque characteristics lines Tq₁, Tq₂ and Tq₃ indicate the change of torque output through the rotary shaft 21 in the electric rotary machines M-1, Ma and Mb, respectively under the condition when the first rotor 10, 10a, 10b rotates 0 [rpm], the second rotor 20-1, 20a, 20b rotates at 750 [rpm]. These changes of torque shown in FIG. 6 indicates when a hybrid electric vehicle drives by electric power and the second rotor 20-1, 20a, 20b has a large change rate of magnetic flux.

The torque characteristic line Tq₂ and the torque characteristic line Tq₃ do not have a large change rate of torque in the elapse of time. On the other hand, although the torque characteristic line Tq₁ has a large change rate of torque when the electric rotary machine M-1 starts to rotate, the output torque becomes gradually stable. When these torque characteristic lines Tq₁, Tq₂ end Tq₃ are compared, FIG. 6 apparently shows a relationship of Tq₁>Tq₂>Tq₃.

The value ΔTqa, which is a difference between the torque characteristic line Tq₂ and the torque characteristic line Tq₃, indicates a torque which is recovered by the magnetic shield effect by the second magnetic passage part 24a.

The value ΔTqb, which is a difference between the torque characteristic line Tq₁ and the torque characteristic line Tq₂, indicates a torque which is increased by a short circuit current and a magnetic flux flowing through the short circuit conductor 25.

Because the torque characteristic line Tq₂ and the torque characteristic, line Tq₃ correspond to the electric rotary machines Ma and Mb as conventional techniques, the structure of the electric rotary machine according to the first exemplary embodiment makes it possible to increase the output torque by the difference value ΔTqb, or the difference value ΔTqa+ΔTqb.

As previously described, the electric rotary machine according to the first exemplary embodiment has the following structure and effects.

The electric rotary machine M-1 according to the first exemplary embodiment has the first rotor 10, the second rotor 20-1 and the stator 30. The first rotor 10 has a plurality of magnetic poles having a different polarity. The stator 30 has the stator winding wires 31. The second rotor 20-1 is arranged between the first rotor 10 and the stator 30.

The second rotor 20-1 has a magnetic iron core. The magnetic iron core of the second rotor 20-1 has at least one or more first magnetic passage parts 23, at least one or more second magnetic passage parts 24, a plurality of the conductor holder parts 26.

At least one or more short circuit conductors 25 are fitted to the corresponding conductor holder parts 26 in the second rotor 20-1.

The magnetic flux passes through the short circuit conductors 25 which are fitted to the conductor holder parts 26 arranged between the stator 30 and the first rotor 10.

The magnetic core of the second rotor 20-1 has at least one or more first magnetic passage parts 23 and at least one or more second magnetic passage parts 24. As shown in FIG. 1 and FIG. 2, the short circuit conductors 25 do not surround each of the first magnetic passage parts 23.

On the other hand, the short circuit conductors 25 surround the corresponding second magnetic passage part 24. The first magnetic passage parts 23, the second magnetic passage parts 24 are alternately arranged in a circumferential direction of the second rotor 20-1.

In the structure of the electric rotary machine M-1, the first magnetic passage parts 23 pass the magnetic flux between the stator 30 and the first rotor 10 in a radial direction of the electric rotary machine M-1. Further, the presence of the second magnetic passage parts 24 cancels the leakage of magnetic flux in the circumferential direction of the second rotor 20-1, as shown in FIG. 3. This structure of the electric rotary machine M-1 makes it possible to increase the magnetic flux effective to increase the torque, and further to increase the torque density and the output power density of the electric rotary machine M-1.

Further, the first magnetic passage parts 23 and the second magnetic passage parts 24 (24A, 24B) are alternately arranged in a circumferential direction of the second rotor 20-1, as shown in FIG. 2 and FIG. 3. This structure makes it possible to alternately arrange the first magnetic passage parts 23 and the second magnetic passage parts 24 (24A, 248), where the first magnetic passage parts 23 bridge the magnetic flux between the stator 30 and the first rotor 10 in a radial direction of the electric rotary machine M-1. The second magnetic passage parts 24 (24A, 24B) shield the magnetic flux in a circumferential direction of the second rotor 20-1. According to the positional relationship between the position Pa and the position Pb in the stator 30 and the first magnetic passage parts 23, the magnetic fluxes in an opposite direction are cancelled relative to each other in the second magnetic passage parts 24A. On the other hand, the magnetic fluxes in the same direction are increased relative to each other in the second magnetic passage parts 24B.

Further, because the adjacent second magnetic passage parts 24A, 248 have a different magnetic phase, it is possible to improve the magnetic modulation capability of the second rotor 20-1. This makes it possible to improve the torque density and the output power density of the electric rotary machine M-1.

Further, the second rotor 20-1 has a structure in which the first magnetic passage parts 23 and the second magnetic passage parts 24 (24A, 248) are connected in series along a circumferential direction of the second rotor 20-1 so that the first magnetic passage parts 23 and the second magnetic passage parts 24 (24A, 24B) make a ring shape, as shown in FIG. 2 and FIG. 3. The second rotor 20-1 having a ring shape increases a centrifugal force resistance without having any special structure because the second rotor 20-1 having a ring shape is composed of the magnetic material elements (first magnetic passage parts 23 and the second magnetic passage parts 24) connected in series along a circumferential direction.

Still further, each of the second magnetic passage parts 24 (24A, 248) is arranged in the second rotor 20-1 to bridge the adjacent first magnetic passage parts 23. The pair of the short circuit conductors 25 surrounds the corresponding first magnetic passage part 24, as shown in FIG. 2 and FIG. 3. The structure of the electric rotary machine M-1 according to the first exemplary embodiment makes it possible to cancel the magnetic flux leakage by the presence of the short circuit conductors 25 because the magnetic flux is generated around the second magnetic passage parts 24 by an induced current flowing in the short circuit conductors 25, and the generated magnetic flux is interlinked with the magnetic flux in the second magnetic passage parts 24A, as shown in FIG. 3. It is therefore possible to increase the output torque of the electric rotary machine M-1 by the magnetic flux generated by the induced current flowing in the short circuit conductors 25 under a large magnetic flux change rate of the second rotor 20-1, as shown by the torque characteristics line Tq1 in FIG. 6.

### Second Exemplary Embodiment

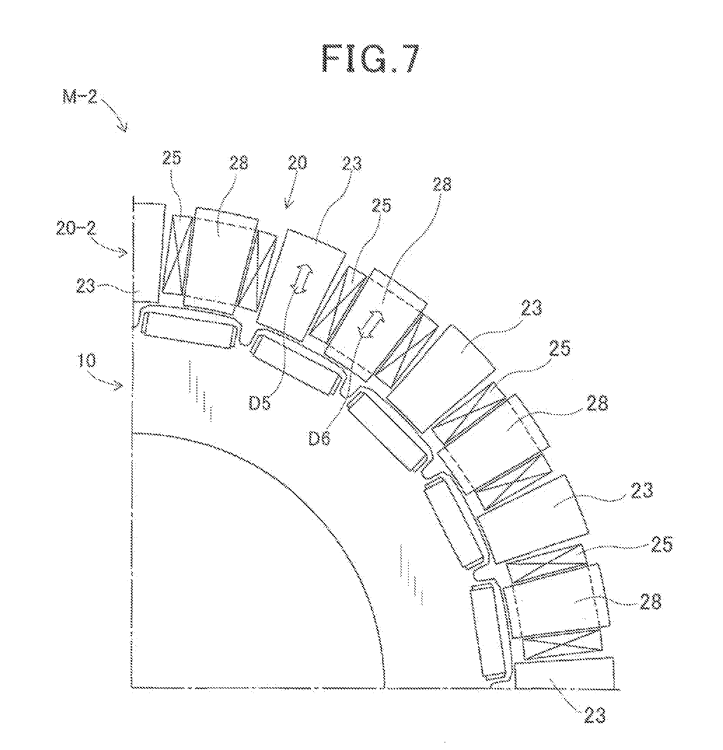

A description will be given of the electric rotary machine M-2 according to the second exemplary embodiment with reference to FIG. 7.

FIG. 7 is a schematic view showing a partial cross section along a radial direction of the electric rotary machine M-2 according to the second exemplary embodiment of the present invention.

The electric rotary machine M-2 according to the second exemplary embodiment shown in FIG. 7 has the same components of the electric rotary machine M-1 according to the first exemplary embodiment shown in FIG. 2 and FIG. 3 other than some components. The same components of the electric rotary machine M-1 according to the first exemplary embodiment will be referred with the same reference numbers and characters, and the explanation of the same components is omitted here.

FIG. 7 shows a schematically and partial cross section of the electric rotary machine M-2 according to the second exemplary embodiment along the II-II line shown in FIG. 1.

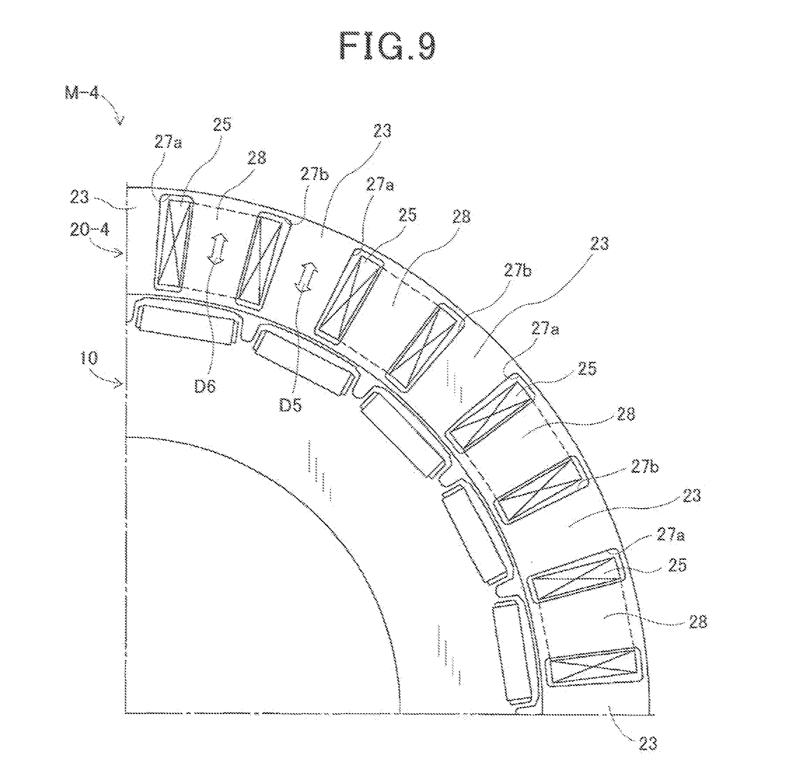

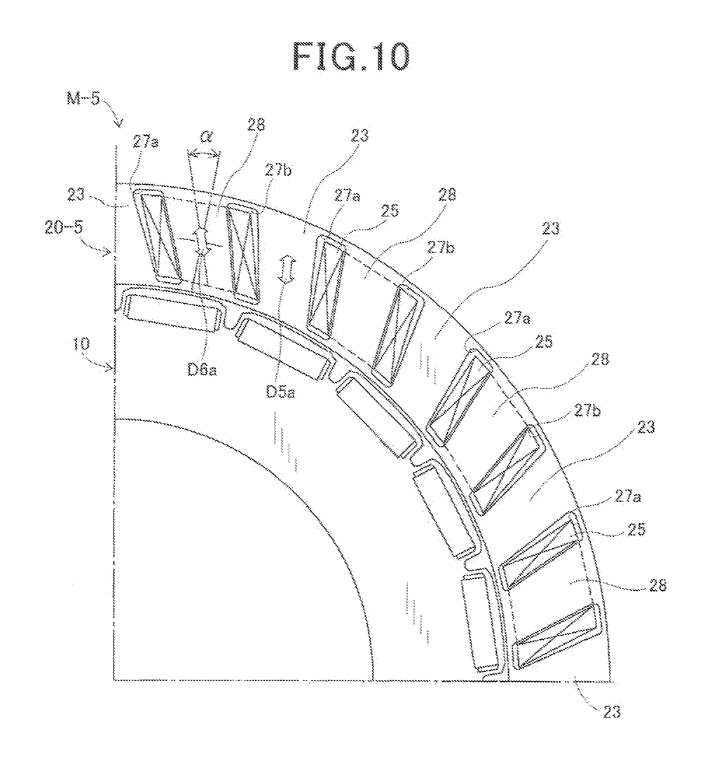

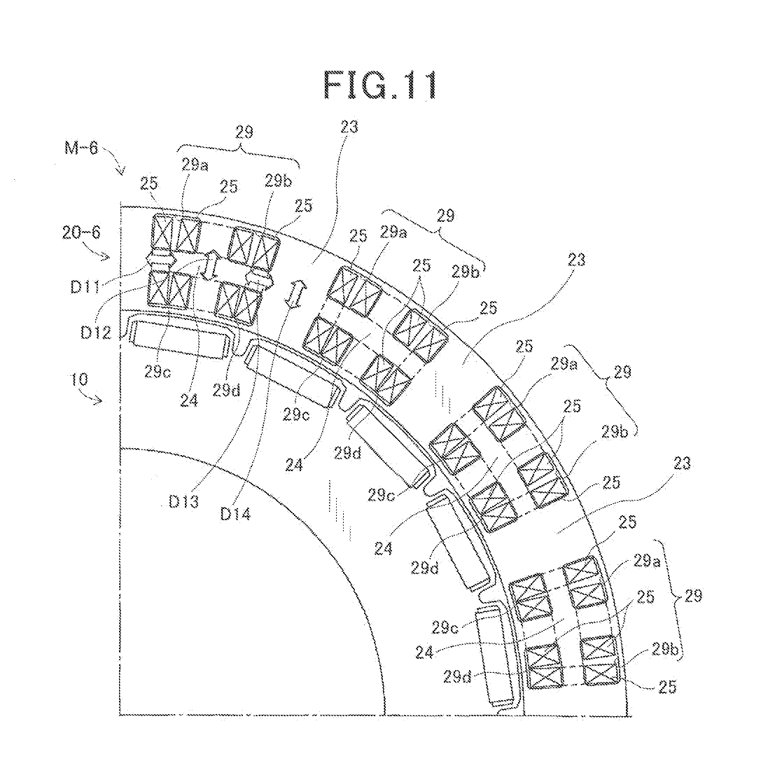

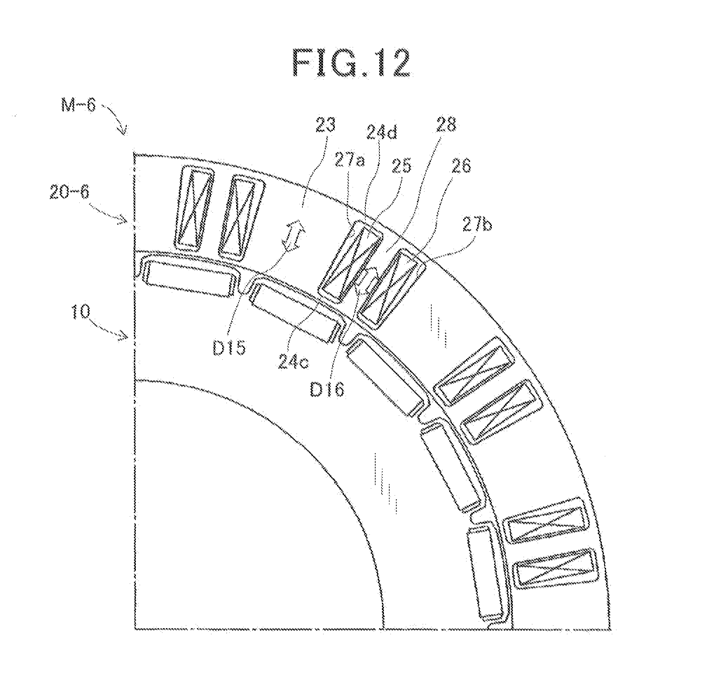

The first rotor 10 is omitted from FIG. 7, FIG. 8A, FIG. 8B, FIG. 9, FIG. 10, FIG. 11 and FIG. 12 for easy understanding.

The rotor 20-2 shown in FIG. 7 has a plurality of first magnetic passage parts 23 and a plurality of second magnetic passage parts 28, The first magnetic passage parts 23 and the second magnetic passage parts 28 are alternately arranged in a circumferential direction of the second rotor 20-2. The second exemplary embodiment allows the first magnetic passage parts 23 and the second magnetic passage parts 28 to an optional size or area.

It is preferable for the first magnetic passage parts 23 to have a large size or area more than that of the second magnetic passage parts 28 in order to increase the magnitude of magnetic flux which passes through the first magnetic passage parts 23 and the stator 30 (omitted from FIG. 7). Further, it is possible to use various methods of connecting the first magnetic passage parts 23 and the second magnetic passage parts 28 together along the circumferential direction of the second rotor 20-2. For example, one method uses a fixing frame or a fixing member of a ring shape in order to connect them alternately along the circumferential direction of the second rotor 20-2.

As shown in FIG. 7, the short circuit conductors 25 are arranged along the circumferential direction of the second magnetic passage parts 28. The adjacent short circuit conductors 25 surround the corresponding second magnetic passage part 28. Because the short circuit conductors 25 are interlinked with the magnetic flux in a radial direction (designated by reference character D6) from the first rotor 10 and the stator 30 (not shown), the induced current generated in the short circuit conductors 25 prevent the magnetic flux from being changed. On the other hand, because there is no short circuit conductor 25 around the first magnetic passage parts 23, the magnetic flux, in a radial direction (designated by reference character D5) in the first magnetic passage parts 23 can be changed.

The first magnetic passage parts 23 allow the magnetic flux to pass between the first rotor 10 and the stator 30. On the other hand, the second magnetic passage parts 28 prevent the magnetic flux from being leaked in a circumferential direction of the second rotor 20-2. That is, the second magnetic passage parts 28 cancel the magnetic flux leakage in a circumferential direction.

Because the first magnetic passage parts 23 and the second magnetic passage parts 28 have a different magnetic flux phase relative to each other, it is possible to improve the magnetic modulation capability.

The structure of the electric rotary machine M-2 according to the second exemplary embodiment has the following actions and effects.

In the structure of the electric rotary machine M-2 according to the second exemplary embodiment, the first magnetic passage parts 23 and the second magnetic passage parts 28 are alternately arranged along a circumferential direction of the second rotor 20-2 in order to separate the magnetic flux periodically along a circumferential direction of the second rotor 20-2. Further, as shown in FIG. 7, the magnetic flux between the stator 30 and the first rotor 10 is bridged and flows along a radial direction of the electric rotary machine M-2 according to the second exemplary embodiment.

This structure makes it possible to arrange the short circuit conductors 25 in the second magnetic passage parts 28 so that the magnetic flux generated by the induced current in the short circuit conductors 25 is interlinked with the magnetic flux in a radial direction of the second rotor 20-2. Further, the induced current in the short circuit conductor 25 generates a magnetic flux having a phase, which is different from the phase of the magnetic flux in the first magnetic passage parts 23, around the second magnetic passage parts 28.

This makes it possible to improve the magnetic modulation capability and to increase the output torque of the electric rotary machine M-2 according to the second exemplary embodiment.

### Third Exemplary Embodiment

A description will be given of the electric rotary machine M-3 according to the third exemplary embodiment of the present invention with reference to FIG. 3A and FIG. 8B.

FIG. 8A is a schematic view showing a partial cross section along a radial direction of the electric rotary machine M-3 according to a third exemplary embodiment of the present invention. FIG. 8B is a schematic view showing a partial cross section of a second rotor 20-3 in the electric rotary machine M-3 according to the third exemplary embodiment.

As previously described, the first exemplary embodiment shows the structure of the electric rotary machine M-1 in which the short circuit conductors 25 are fitted and fixed into the notch part 26a and the notch part 26b, respectively. The notch parts 26a and 26b are arranged at the outer circumferential part and the inner circumferential part of the second rotor 20-1, respectively.

On the other hand, the third exemplary embodiment shows the structure in which through holes 20h are formed at the outer peripheral part close to the outer peripheral surface of the second rotor 20-3 and the inner peripheral part close to the inner peripheral surface of the second rotor 20-3. That is, as shown in FIG. 8A, a pair of the through holes 20h is formed between the adjacent first magnetic passage parts 23, and one short circuit conductor 25 in a pair is fitted and fixed into the through hole 20h formed at the outer peripheral part and the other short circuit conductor 25 in the pair is fitted and fixed into the through hole 20h formed at the inner peripheral part.

As shown in FIG. 8A, the second magnetic passage part 24 is arranged between a pair of the through holes 20h.

Similar to the effects of the electric rotary machine M-1 according to the first exemplary embodiment shown in FIG. 2 and FIG. 3, the structure of the electric rotary machine M-3 according to the third exemplary embodiment has the following effects:

(a) the magnetic flux can pass between the stator 30 and the first rotor 10 through the first magnetic passage parts 23;

(b) the magnetic flux in a circumferential direction (designated by reference character D7) of the second rotor 20-3 is magnetically separated from the magnetic flux passing through the stator 30 and the first rotor 10 in the second magnetic passage part 24A; and

(c) the magnetic flux is constructively increased in the second magnetic passage part 24B.

The above effects make it possible to improve the magnetic modulation capability and effects of the second rotor 20-3 in the electric rotary machine M-3 according to the third exemplary embodiment.

Further, the third exemplary embodiment allows the electric rotary machine M-3 to have a structure shown in FIG. 8B. In which cavity parts 20i are formed in the second rotor 20-3. Each cavity part 20i does not have a simple box structure in which one surface is opened. That is, as shown in FIG. 8B, each cavity part 20i has a structure in which the second magnetic passage part 24 (24A, 248) is bridged between the adjacent first magnetic passage parts 23 in the second rotor 20-3. In other words, each cavity part 20i has a thickness Δd at one surface side of the second rotor 20-3, as shown in FIG. 8B.

Similar to the effects of the electric rotary machine M-1 according to the first exemplary embodiment shown in FIG. 2 and FIG. 3, the structure of the electric rotary machine M-3 according to the third exemplary embodiment shown in FIG. 8B has the following effects:

(a) the magnetic flux can pass between the stator 30 and the first rotor 10 through the first magnetic passage parts 23;

(b) the magnetic flux toward the circumferential direction (designated by reference character D7) of the second rotor 20-3 is magnetically separated from the magnetic flux passing through the stator 30 and the first rotor 10 in the second magnetic passage part 24A; and

(c) the magnetic flux is constructively increased in the second magnetic passage part 24B.

The above effects make it possible to improve the magnetic modulation effects of the second rotor 20-3 in the electric rotary machine M-3 according to the third exemplary embodiment.

### Fourth Exemplary Embodiment

A description will be given of the electric rotary machine M-4 according to the fourth exemplary embodiment of the present invention with reference to FIG. 9.

FIG. 9 is a schematic view showing a partial cross section along a radial direction of the electric rotary machine M-4 according to the fourth exemplary embodiment.

In the structure of the electric rotary machine M-2 according to the second exemplary embodiment shown in FIG. 7, the second rotor 20-2 is composed of a plurality of the first magnetic passage parts 23, a plurality of the second magnetic passage parts 28 and the short circuit conductors 25 so that the first magnetic passage part 23 and the second magnetic passage part 28 which are adjacent relative to each other are connected through the corresponding short circuit conductor 25 made of magnetic material element. In other words, the adjacent short circuit conductors 25 surround the corresponding second magnetic passage part 28 in the structure shown in FIG. 7.

As shown in FIG. 9, the electric rotary machine M-4 according to the fourth exemplary embodiment has the structure in which a plurality of pairs (for example, sixteen pairs) of through holes 27a and 27b is arranged along a circumferential direction of a second rotor 20-4 having a ring shape. A pair of the short circuit conductors 25 is fitted and fixed into a pair of the through holes 27a and 27b in order to surround the corresponding second magnetic passage part 28. This structure makes it possible to prevent the magnetic flux from being changed by an induced current generated in the short circuit conductor 25 because the induced magnetic flux is interlinked with the magnetic flux from the first rotor 10 and the stator 30 (not shown) in a radial direction of the electric rotary machine M-4.

On the other hand, the first magnetic passage parts 23 do not prevent the magnetic flux from being changed in a direction D5 shown in FIG. 9. The magnetic flux passes between the first rotor 10 and the stator 30 through the first magnetic passage part 23. The second magnetic passage parts 28 cancel the leakage of the magnetic flux in a circumferential direction.

Accordingly, because the first magnetic passage parts 23 and the second magnetic passage parts 28 have a different magnetic flux phase relative to each other, this makes it possible to improve the magnetic modulation capability. It is possible for the second rotor 20-4 to have the cavity parts 20i shown in FIG. 8B instead of using the through holes 27a and 27b. This makes it also possible to have the same effects of the electric rotary machine M-3 according to the third exemplary embodiment shown in FIG. 8B.

### Fifth Exemplary Embodiment

A description will be given of the electric rotary machine M-5 according to the fifth exemplary embodiment of the present invention with reference to FIG. 10.

FIG. 10 is a schematic view showing a partial cross section along a radial direction of the electric rotary machine M-5 according to the fifth exemplary embodiment.

In the structure of the electric rotary machine M-4 according to the fourth exemplary embodiment shown in FIG. 9, the through holes 27a and 27b are formed along a radial direction of the second rotor 20-4.

On the other hand, the electric rotary machine H-5 according to the fifth exemplary embodiment shown in FIG. 10 has the through holes 27a and 27b along a direction which intersects to a radial direction of the second rotor 20-5.

In the structure of the through holes 27a and 27b shown in FIG. 10, the through holes 27a and 27b are inclined to a radial direction by an angle α to a left side (to a counter clockwise direction). This structure makes the magnetic flux, which passes between the first rotor 10 and the stator 30, to incline a direction (designated by reference character D5a shown in FIG. 10). On the other hand, it is possible to prevent the magnetic flux, which inclines to a direction designated by an arrow 6Da in the second magnetic passage parts 28, from being changed by an induced current generated and flowing in the short circuit conductors 25.

The magnetic flux passes between the first rotor 10 and the stator 30 through the first magnetic passage parts 23. On the other hand, the second magnetic passage parts 28 cancel any leakage of the magnetic flux in a circumferential direction of the second rotor 20-5.

Accordingly, because the first magnetic passage parts 23 and the second magnetic passage parts 28 have a different magnetic flux phase relative to each other, it is possible to improve the magnetic modulation capability. The second rotor 20-5 can have the cavity parts 201 shown in FIG. 8B instead of using the through holes 27a and 27b. This makes it also possible to have the same effects of the electric rotary machine M-3 according to the third exemplary embodiment shown in FIG. 8B

### Sixth Exemplary Embodiment

A description will be given of the electric rotary machine M-6 according to the sixth exemplary embodiment of the present invention with reference to FIG. 11.

As previously described, the first exemplary embodiment shows the structure of the electric rotary machine M-1 to have a plurality of the pairs of the notch parts 26a and 26b shown in FIG. 2. The second exemplary embodiment shows the structure of the electric rotary machine M-2 to have a plurality of the first magnetic passage part 23 and the second magnetic passage parts 28 which are alternately arranged along a circumferential direction of the second rotor 20-2 shown in FIG. 7. In particular, the first and second exemplary embodiments have the common structure in which each second magnetic passage part 24 (shown in FIG. 2) is surrounded or sandwiched by the adjacent short circuit conductors 25 in a pair, and each second magnetic passage part 28 (shown in FIG. 7) is surrounded or sandwiched by the adjacent short circuit conductors 25.

However, the concept of the present invention is not limited by these structures. It is possible to have a structure in which each second magnetic passage part 24 is surrounded by a plurality of short circuit conductors 25.

FIG. 11 is a schematic view showing a partial cross section along a radial direction of the electric rotary machine M-6 according to a sixth exemplary embodiment of the present invention.

As shown in FIG. 11, the electric rotary machine M-6 has the second rotor 20-6 in which four through holes 29a, 29b, 29c and 29d are formed in each second magnetic passage part 24, and the short circuit conductor 25 is arranged between the adjacent through holes 29a and 29b, the short circuit conductor 25 is arranged between the adjacent through holes 29b and 29d, the short circuit conductor 25 is arranged between the adjacent through holes 29d and 29c, and the short circuit conductor 25 is arranged between the adjacent through holes 29c and 29a.

That is, each second magnetic passage part 24 in the second rotor 20-6 has a cross shape. In the structure of the second rotor 20-8 shown in FIG. 11, the second magnetic passage part 24 bridges the magnetic flux in a circumferential direction designated by reference character D11 and in a radial direction designated by reference character D12. However, the change of the magnetic flux of the second magnetic passage part 24 in the circumferential direction D11 is prevented by the short circuit current which flows in the short circuit conductors 25 arranged between the through holes 29c and 29a and the short circuit current flowing in the short circuit conductors 25 arranged between the through holes 29b and 29d.

Similarly, the change of the magnetic flux of the second magnetic passage part 24 in the radial direction D12 is prevented by the short circuit current which flows in the short circuit conductors 25 arranged between the through holes 29a and 29b and the short circuit current flowing in the short circuit conductors 25 arranged between the through holes 29c and 29d.

On the other hand, the first magnetic passage parts 23 allows the magnetic flux to pass between the first rotor 10 and the stator 30.

Accordingly, because the first magnetic passage parts 23 and the second magnetic passage parts 24 have a different magnetic flux phase relative to each other, it is possible to improve the magnetic modulation capability.

It is possible for the second rotor 20-6 to have the cavity parts 201 shown in FIG. 8B instead of using the through holes 29a, 29b, 29c and 29d. This makes it also possible to have the same effects of the electric rotary machine M-3 according to the third exemplary embodiment shown in FIG. 5B.

### Seventh Exemplary Embodiment

A description will be given of the electric rotary machine M-7 according to the seventh exemplary embodiment of the present invention with reference to FIG. 12.

As previously described, the fourth exemplary embodiment shows the structure of the electric rotary machine M-4 to have a plurality of the pair (for example, the sixteenth pairs) of the through holes 27a and 27b formed in a circumferential direction in the second rotor 20-4 having a ring shape.

However, the concept of the present invention is not limited by the structures. It is possible to have a structure shown in FIG. 12.

FIG. 12 is a schematic view showing a partial cross section along a radial direction of an electric rotary machine M-7 according to a seventh exemplary embodiment of the present invention.

As shown in FIG. 12, the second rotor 20-7 in the electric rotary machine M-7 has an inner circumferential bridge part 24c and an outer circumferential bridge part 24d in addition to the structure of the second rotor 20-4 in the electric rotary machine M-4 shown in FIG. 9.

The inner circumferential bridge part 24c is magnetically separated from the outer circumferential bridge part 24d by decreasing the width of each of the inner circumferential bridge part 24c and the outer circumferential bridge part 24d or by executing a non-magnetic treatment process. In addition, the width between the through holes 27a and 27b measured in a circumferential direction is different from the width between the through holes measured in a circumferential direction shown in FIG. 12.

In the structure of the second rotor 20-7 shown in FIG. 12, because the short circuit conductor 25 is arranged in the second magnetic passage parts 28 so that the magnetic flux generated by the short circuit conductor 25 is interlinked with the magnetic flux in a radial direction between the first rotor 10 and the stator 30, it is possible for the induced current in the short circuit conductors 25 to prevent the magnetic flux from being changed.

On the other hand, because there is no short circuit conductor 25 around the first magnetic passage parts 23, the magnetic flux is changed in a radial direction designated by reference character D15.

This makes it possible for the first magnetic passage parts 23 and the second magnetic passage parts 28 to have a different magnetic flux phase relative to each other. It is therefore possible to improve the magnetic modulation capability, and to increase the output torque of the electric rotary machine M-7 in a wide operation range thereof.

When the second rotor 20-7 to have a structure in which the length L1 of the first magnetic passage part 23 in a circumferential direction is not less than twice (L1≦L2) of the length L2 of the second magnetic passage part 28, it is possible to further increase the output torque of the electric rotary machine.

As previously described, the first to seventh exemplary embodiments show the structure of the electric rotary machines M-1 to M-7 in which the first magnetic passage parts 23 and the second magnetic passage parts 24 are alternately arranged in a circumferential direction of the second rotor 20-1 shown in FIG. 2. The second exemplary embodiment shows the structure in which the first magnetic passage parts 23 and the second magnetic passage parts 28 are alternately arranged in a circumferential direction of the second rotor 20-2 shown in FIG. 7.

However, the concept of the present invention is not limited by the structures disclosed in the first exemplary embodiment and the second exemplary embodiment. It is possible to have a structure in which some of the first magnetic passage parts 23 and the second magnetic passage parts 28 are not arranged in an alternated arrangement structure. For example, some of the second magnetic passage parts 24B shown in FIG. 3 are eliminated. Although such a part having the non-alternated arrangement structure decreases the effects of the magnetic modulation capability and effects disclosed in the first and second exemplary embodiments, the part of the alternated arrangement structure of the first magnetic passage parts 23 and the second magnetic passage parts 24, 28 provides the same actions and effects of the first and seventh exemplary embodiments.

As previously described, the first to seventh exemplary embodiments show the structure of the electric rotary machines in which the second rotor is arranged between the first rotor 10 and the stator 30 and the stator 30 is arranged at the outermost circumference of the electric rotary machine. However, the concept of the present invention is not limited by these structures. It is possible for the electric rotary machine to have a structure in which the first stator 10 is arranged at the outermost circumference, and the stator 30 is arranged at the innermost circumference.

Further, as previously described, FIG. 1 shows a structure of the electric rotary machines M-1 to M-7 in which the first rotor 10, the second rotor 20 (20-1 to 20-7) and the stator 30 are arranged in line. However, the concept of the present invention is not limited by these structures. It is possible to form the electric rotary machine to have a structure in which the first rotor 10, the second rotor 20 (20-1 to 20-7) and the stator 30 are not arranged in line. For example, it is possible for the electric rotary machine to have a structure in which the line on which the first rotor 10 and the second rotor 20 (20-1 to 20-7) are arranged intersects with the line on which the second rotor 20 (20-1 to 20-7) and the stator 30. For example, an axial-gap motor has the above structure. Because such an axial-gap motor has a structure in which the second rotor 20 is arranged between the first rotor and the stator, it is possible to have the same actions and effects of the electric rotary machines according to the first and seventh exemplary embodiments.

As previously described, the first to seventh exemplary embodiments show the structure of the electric rotary machine in which the engine shaft 12 is engaged with the rotary shaft 11, and the rotary shaft 12 is engaged with the transmission shaft 22 shown in FIG. 2. However, the concept of the present invention is not limited by this structure. It is possible to engage the power transmission mechanism with one or both the connection between the rotary shaft 11 and the engine shaft 12 and the connection between the rotary shaft 21 and the transmission shaft 22. The power transmission mechanism contains a cams, racks, pinions, gears, and etc. Because this structure inputs the power through the rotary shaft 11 and outputs the converted power to the transmission shaft 22, it is possible to have the same actions and effects of the electric rotary machine according to the first to seventh exemplary embodiments.

As previously described, the first to seventh exemplary embodiments shows the structure of the electric rotary machine in which the rotary shaft 11 is an input shaft and the rotary shaft 21 is an output shaft shown in FIG. 1. However, the concept of the present invention is not limited by this structure. It is possible to use the rotary shaft 21 as the input shaft and to use the rotary shaft 11 as the output shaft. In the structure shown in FIG. 1, the rotary shaft 21 is engaged with the engine shaft 11 and the rotary shaft 11 is engaged with the transmission shaft 22. Because the first rotor 10 and the second rotor 20 (20-1 to 20-7) are a rotating element, it is possible to optionally selects them as the input shaft and the output shaft. This makes it possible to have the same actions and effects of the first and seventh exemplary embodiments.

As previously described, the first to seventh exemplary embodiments disclose the electric rotary machine which is used in a hybrid electric vehicle. However, the concept of the present invention is not limited by this structure. It is possible to apply the electric rotary machine according to the first to seventh embodiments to electric vehicles, and transportation units (for example, cruise ship, container ship, and aircraft). That is, it is possible to apply the electric rotary machine having the rotary shaft 11 and the rotary shaft 21 shown in FIG. 1 to various types of transportation units. These cases can have the same actions and effects of the electric rotary machines according to the first to seventh exemplary embodiments.

### Other Features and Effects of the Present Invention

In the electric rotary machine as another aspect of the present invention, the first magnetic passage parts and the second magnetic passage parts in the second rotor are alternately arranged in a circumferential direction of the second rotor. This structure alternately makes the first magnetic passage parts and the second magnetic passage parts in the second rotor. In particular, the first magnetic passage part bridge the magnetic flux between the first rotor and the stator in a radial direction of the second rotor. The second magnetic passage parts shield the leakage of the magnetic flux in a circumferential direction of the second rotor. Further, one part of the second magnetic passage parts cancels the magnetic fluxes of an opposite direction relative to each other, and the other part of the second magnetic passage parts increases the magnetic flux in the same direction relative to each other. Still further, because the adjacent second magnetic passage parts have the magnetic fluxes of a different phase, it is possible to improve the magnetic modulation capability of the second rotor. This makes it possible to further increase the torque density and the output power density of the electric rotary machine.

In the electric rotary machine as another aspect of the present invention, the magnet iron core of the second rotor is made of magnetic material. The magnetic material has a structure in which the first magnetic passage parts and the second magnetic passage parts are connected in series along a circumferential direction of the second rotor so that the first magnetic passage parts and the second magnetic passage parts make a ring shape. Because the second rotor has the magnetic material having a ring shape connected in a circumferential direction of the second rotor, it is possible to maintain the centrifugal force resistance without using any special supporting structure.

In the electric rotary machine as another aspect of the present invention, the second magnetic passage parts are arranged in the second rotor to bridge and flow the magnetic flux in the adjacent first magnetic passage parts. The short circuit conductors surround the corresponding second magnetic passage part are arranged so that a magnetic flux generated in the corresponding short circuit conductors is interlinked with the magnetic flux of the second magnetic passage part.

This structure of the second rotor makes it possible to cancel the leakage of the magnetic flux in the second magnetic passage part by the magnetic flux generated by the induced current of the short circuit conductor which is interlinked with the magnetic flux of the second magnetic passage part. Accordingly, it is possible to increase the output torque of the electric rotary machine by such an induced current flowing in the short circuit conductor even if the electric rotary machine works under a large change rate of the magnetic flux.

In the electric rotary machine as another aspect of the present invention, the first magnetic passage parts and the second magnetic passage parts are alternately arranged along a circumferential direction of the second rotor so that the magnetic flux is bridged and flows between the first rotor and the stator in a radial direction of the electric rotary machine.

This structure of the electric rotary machine makes it possible to improve the magnetic modulation effects and to increase the output torque in a wide operation range of the electric rotary machine because the short circuit conductors are arranged in the second magnetic passage parts in order to generate a magnetic flux which is interlinked with the magnetic flux in the second magnetic passage part and to generate the magnetic flux around the second magnetic passage part having a different phase of the magnetic flux in the first magnetic passage part.

While the specific exemplary embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. An electric rotary machine comprising:
a stator comprising stator winding wires;
a first rotor comprising a plurality of magnetic poles having a different polarity; and
a second rotor being arranged between the first rotor and the stator, and the first rotor, the second rotor and the stator being arranged on a coaxial shaft, the second rotor comprising a magnetic iron core and a plurality of short circuit conductors, the magnetic iron core of the second rotor comprising at least one or more first magnetic passage parts, at least one or more second magnetic passage parts and conductor holder parts, both ends of each of the short circuit conductors being electrically connected to make a short circuit, and the short circuit conductors being fitted to the corresponding conductor holder parts, the first magnetic passage parts having no short circuit conductor surrounding them, and the short circuit conductors surrounding each of the second magnetic passage parts, and the first magnetic passage parts and the second magnetic passage parts in the second rotor being adjacently arranged in a circumferential direction of the second rotor.

2. The electric rotary machine according to claim 1, wherein the first magnetic passage parts and the second magnetic passage parts in the second rotor are alternately arranged in a circumferential direction of the second rotor.

3. The electric rotary machine according to claim 1, wherein the magnet iron core of the second rotor is made of magnetic material having a structure in which the first magnetic passage parts and the second magnetic passage parts are connected in series along a circumferential direction of the second rotor so that the first magnetic passage parts and the second magnetic passage parts make a ring shape.

4. The electric rotary machine according to claim 1, wherein the second magnetic passage parts are arranged in the second rotor to bridge the magnetic flux in the adjacent first magnetic passage parts, and the short circuit conductors surround the corresponding second magnetic passage part are arranged so that a magnetic flux generated in the corresponding short circuit conductors is interlinked with the magnetic flux of the second magnetic passage part.

5. The electric rotary machine according to claim 1, wherein the first magnetic passage parts and the second magnetic passage parts are alternately arranged along a circumferential direction of the second rotor so that the magnetic flux is bridged and flow between the first rotor and the stator in a radial direction of the electric rotary machine.

6. The electric rotary machine according to claim 1, wherein notch parts are formed as the conductor holder parts at an outer peripheral part and an inner peripheral part of the second rotor, and the short circuit conductors are engaged with the conductor holder parts, respectively.

7. The electric rotary machine according to claim 6, wherein through holes are formed instead of the notch parts as the conductor holder parts, and the short circuit conductors are engaged with the through holes, respectively.

8. The electric rotary machine according to claim 1, wherein through holes are formed as the conductor holder parts along a circumferential direction of the second rotor, and the short circuit conductors are engaged with the through holes, respectively.

9. The electric rotary machine according to claim 8, wherein the through holes as the conductor holder parts are formed to incline by a predetermined angle to a radial direction of the electric rotary machine, and the short circuit conductors are engaged with the through holes, respectively.

10. The electric rotary machine according to claim 1, wherein a plurality of the short circuit conductors surround each of the corresponding second magnetic passage parts.

11. The electric rotary machine according to claim 8, wherein through holes are formed as the conductor holder parts along a circumferential direction of the second rotor, and the short circuit conductors are engaged with the through holes, respectively.
